(19) United States
(12) Patent Application Publication
(10) Pub. No.: US 2020/0068941 A1
(43) Pub. Date: Mar. 5, 2020

(54) HAY-BASED MATERIAL FREE OF RESPIRABLE DUST EMISSION: PROCESS FOR ITS PREPARATION, USE AND ASSOCIATED MACHINE

(71) Applicant: NUTRI-FOIN SYSTÈME INC, Mirabel (CA)

(72) Inventors: Serge GUAY, Mirabel (CA); Danielle LEVAC, Mirabel (CA)

(21) Appl. No.: 16/489,343

(22) PCT Filed: Feb. 27, 2018
(86) PCT No.: PCT/CA2018/050221

§ 371 Date: Aug. 27, 2019

Related U.S. Application Data
(60) Provisional application No. 62/463,953, filed on Feb. 27, 2017.
(60) Provisional application No. 62/565,602, filed on Sep. 29, 2017.

(51) Int. Cl. A23N 17/00; A01K 5/00; A23K 10/33; A23K 10/20; A23K 20/28; A23K 20/158; A23K 50/20

(52) U.S. Cl. CPC A23N 17/007; A01K 5/004; A23K 10/33; A23K 50/20; A23K 20/28; A23K 20/158; A23K 10/20

(57) ABSTRACT

A process for preparing a hay-based material for feeding a horse is provided. The process comprises chopping/blending together hay and a binding agent or dust-trapping agent. A machine for conducting the process of the invention is also provided. The hay-based material of the invention may be used to feed horses to improve their general health, particularly horses with severe asthma.

### CROSS REFERENCE TO RELATED APPLICATIONS

This application claims benefit of U.S. provisional applications Ser. No. 62/463,953 filed on Feb. 27, 2017 and Ser. No. 62/565,602 filed on Sep. 29, 2017. These provisional applications are incorporated herein in their entirety by reference.

### FIELD OF THE INVENTION

The present invention relates generally to hay-based materials for feeding herbivorous animals. More specifically, the invention relates to the treatment of hay for preparing a material that is substantially free of antigens and other respirable dust particles. The treatment process of the invention comprises, in combination, a mechanical manipulation and use of a binding agent. Hay-based materials treated by the process of the invention may be used in animals with severe asthma to improve their general health.

### BACKGROUND OF THE INVENTION

The problem of Severe Equine Asthma (“SEA”) is the most common respiratory disorder plaguing stabled horses, and is quite widespread with the most severe form affecting ˜15% of the equine population in the northern hemisphere. There are an estimated ˜150,000 horses in Canada [4] which suffer from SEA, and roughly ˜1,400,000 horses in the United States [5]. In addition, SEA in its mild and moderate forms is estimated to possibly affect up to 75% of horses. SEA is a chronic disease for which there is currently no cure. The negative impacts of SEA are quite significant with horses experiencing frequent coughing, inability to work, and labored breathing at rest, often leading to a premature retirement or euthanasia. Clinical signs develop in susceptible animals when they inhale environmental antigens (respirable organic dust particles), especially those present in hay. Studies have shown that the most important determinant of exposure to respirable organic dust for horses is their feed, especially hay [1].

First line treatment of episodes of SEA often involves the systemic administration of drugs such as corticosteroids and bronchodilators. However, these drug treatments have several important drawbacks. Firstly, the associated costs are prohibitive. Indeed, the costs of administering drugs currently indicated for treatment of SEA carry prohibitive costs, ranging from ˜$1,000-$5,000 annually (including consultations). This calculation is based on the assumption that an affected horse experiences only 1 severe episode of SEA during the year, requiring only a short-term regimen of drugs (1 to 2 months). Hence this implies significant higher costs for horses receiving long-term drug administration. Secondly, these drugs are not indicated for long-term use. Current drug treatments for SEA are not indicated for long-term use, which conflicts with the ongoing treatment needs of affected horses due to the chronic nature of their disorder. Studies have shown the potential for severe adverse effects from these drugs, such as laminitis in connection with corticosteroid administration, and bacterial pneumonia having been reported after long-term administration of prednisolone [2]. Thirdly, these drugs are not always effective. Certain studies have shown that lung inflammation associated with SEA does not improve even after long-term drug administration. A study found that long-term fluticasone treatment did not reverse airway inflammation when SEA horses were kept indoors and exposed to hay even after 6 months [1]. In addition, unless they are combined with strict management changes of the horse's breathing environment, clinical signs of SEA generally rapidly recur after cessation of drug treatment regimens.

Other solutions relate to breathing environment management techniques. The results of recent long-term studies emphasize that control of horses' breathing environment remains the best option for long-term treatment of SEA. This can currently be achieved by horse owners using several techniques, each having their own disadvantages which are described below. Evidence demonstrates however that owners are more compliant at using prescribed drugs than at changing their management habits [2], which overall is mainly due to the onerous time and labor requirements involved, or the associated higher costs of feeding.

One such breathing environment management technique involves hay soaking. Soaking hay in water before feeding has been demonstrated to reduce emission of allergens by washing away respirable dust particles. This technique however has several drawbacks. For example, it has onerous time and labor requirements. Recommended time to soak hay prior to feeding (if in cold water) is typically 60 minutes, which does not include the time and labor required to first break apart the hay to shake out excess dust and leaves. Post-soaking hay is waterlogged, requiring more labor to transport, and the process can be significantly hampered, or even rendered impossible to perform during winter. This process also requires efforts to dispose of the water. It has been reported that hay soaking was not followed by owners after a short period of time [2]. Also, hay soaking leads to reduced nutritive content. The act of soaking the hay in water for prolonged periods is known to dilute the nutritive content of the hay. Moreover, there is a risk of toxicity associated to hay soaking. Exposing hay to moisture has the effect of increasing the rate of fermentation, which leads to the risk of development of harmful toxins such as botulism. If not consumed within a 12-hour timeframe, it is not recommended to give hay which has been soaked to horses due to the associated risk of toxicity.

Another breathing environment management technique involves hay steaming. Commercial hay steamers effectively eliminate the organic dust content of hay by exposing it to high heat. However, there are several drawbacks to using hay steamers. Firstly, the associated time and labor requirements are high. Indeed, hay must be broken apart manually before being used in a commercial hay steamer. Recommended steaming times range from 30-45 minutes per feeding, which must be conducted at each interval as overnight storage of steamed hay is not advised. Secondly, constraints related to capacity are noted. With the design of commercial hay steamers incorporating a closed system, the capacity of these devices is typically limited to 1 bale of hay per operation cycle. Due to the time required to produce 1 feeding, in an environment of multiple horses, hay steamers limited capacity pose a significant issue for most horse owners. Thirdly, a reduced nutritive content is associated to hay steaming. Similar to soaking, the act of steaming hay with water for prolonged periods is known to dilute the nutritive content of the hay. Fourthly, a risk of toxicity is associated to hay steaming. Similar to soaking, steaming exposes hay to moisture leading to the risk of development of harmful toxins if not consumed within a 12-hour timeframe.

Further breathing environment management techniques include replacing hay with a dust-free feed source such as pelleted feeds, or silage. While these alternatives are effective in reducing exposure to allergens, each carry their own disadvantages. For example, pelleted feeds carry significant risks as well as increased costs. It is recommended to soak pelleted feeds for ˜20 minutes prior to feeding to avoid risk of choke, a condition occurring when a horse eats too rapidly resulting in a blockage of the esophagus, and normally requiring veterinary attention. In addition, administering pelleted foods carry significant risk of intestinal blockage (“colic”), which is the number 1 cause of medical mortality among horses. It is also required to double the frequency of feedings per day (to 3-4 times) to help simulate the horse's natural tendency to exercise continuous chewing throughout the day, thereby discouraging the development of undesirable behaviors. Finally, purely pelleted feed diets are inherently fiber-deficient and thus need to be supplemented with fiber and fats, increasing the overall daily cost of feeding by ˜60% as compared to dry hay. Another disadvantage relates to the fact that silage comes with high risk of toxicity. Silage is generally not considered preferable to high quality dry hay given the higher cost, and associated risk of toxicity. Due to a higher moisture content than conventional hay, if not consumed within a 12-hour timeframe, silage carries the risk of development of botulism toxins.

The inventors are also aware of the following documents: CA 2,727,663; CA 2,977,672; CN 104585479; ECOEQUINE, “Dengie, aka Chopped Hay” The Equine Nutrition Nerd (Jul. 24 2014); DE 10256868; U.S. 2016-100610.

There is a need for hay-based materials that are free of emission of antigens and other respirable dust particles. There is a need for production techniques of such materials that are efficient, fast and cost-effective.

### SUMMARY OF THE INVENTION

The inventors have designed and prepared a hay-based material that is free of emission of antigens and other respirable dust particles. The material according to the invention comprises hay and a binding agent or dust-trapping agent. The material may also comprise a nutrients mix. The material may be used in horses with severe asthma to improve their general health.

The process for the preparation of the material according to the invention comprises a combination of a mechanical manipulation of hay including chopping/blending, and use of a binding agent or dust-trapping agent.

The machine for the preparation of the material according to the invention comprises a chopper/blender and a dispenser operatively attached thereto. The machine of the invention allows for a binding agent or dust-trapping agent to be dispensed into the chopper/blender during operation thereof. The binding agent or dust-trapping agent may be in substantially liquid form and the dispenser may be a liquid dispenser.

The invention thus provides the following according to aspects thereof.

[1] A process for preparing a hay-based material, comprising chopping/blending together hay and a binding agent or dust-trapping agent.
[2] A process for preparing a hay-based material, comprising chopping/blending together hay, a nutrients mix and a binding agent or dust-trapping agent.
[3 A process for preparing a hay-based material, comprising, in combination: a mechanical operation involving chopping/blending of hay, and use of a binding agent or dust-trapping agent.
[4] A process for preparing a hay-based material, comprising, in combination: a mechanical operation involving chopping/blending of hay and a nutrient mix, and use of a binding agent or dust-trapping agent.
[5] A process for preparing a hay-based material, comprising: (a) chopping hay to obtain a chopped hay; (b) adding a binding agent or dust-trapping agent to the chopped hay to obtain a mixture; and (c) blending the mixture to obtain the hay-based material.
[6] A process according to [5] above, further comprising (al) mixing hay with a nutrients mix prior to conducting step (a).
[7] A process for preparing a hay-based material, comprising: (a) providing hay into a chopper/blender; (b) providing a binding agent or dust-trapping agent into a dispenser that is operatively attached to the chopper/blender; (c) operating the chopper/blender; (d) causing the dispenser to dispense the binding agent or dust-trapping agent into the chopper/blender; (e) stopping operation of the chopper/blender and (f) retrieving the material.
[8] A process according to [7] above, further comprising (al) mixing hay with a nutrients mix prior to conducting step (a).
[9] A process according to [7] above, wherein step (d) proceeds automatically after a set period of time.
[10] A process according to [7] above, wherein step (e) is performed after a period of time.
[11 A process according to [7] above, further comprising (g) assessing the presence of any dust in the material, and optionally repeating at least one of steps (c)-(f).
[12] A process according to [7] above, further comprising (h) assessing the consistency of the material, and optionally repeating at least one of steps (c)-(f).
[13] A process according to [7] above, further comprising (i) storing the material for future use.
[14] A process according to [7] above, wherein the binding agent or dust-trapping agent is in substantially liquid form and the dispenser is a liquid dispenser.
[15] A method for treating hay, comprising, in combination, a mechanical manipulation of hay and use of a binding agent or dust-trapping agent.
[16] A method according to [15] above, wherein hay comprises a nutrients mix.
[17] A hay-based material obtained by the process as defined in any one of [1]-[14] above.
[18] Hay treated by the method as defined in [15] or [16] above.
[19] A machine for producing hay-based material, comprising a hay chopper/blender and a dispenser operatively attached thereto, wherein a binding agent or dust-trapping agent provided into the dispenser is dispensed into the chopper/blender during operation thereof.
[20] A machine according to [19] above, wherein the hay comprises a nutrients mix.
[21] A machine according to [19] above, wherein the binding agent or dust-trapping agent is in substantially liquid form and the dispenser is a liquid dispenser.
[22] A process, material or machine as defined in any one of [1]-[21] above, wherein the hay-based material is for feeding a horse.
[23] A process, method, hay-based material, treated hay or machine as defined in any one of [1]-[21] above, wherein the binding agent or dust-trapping agent is consumable by a horse; preferably the binding agent or dust-trapping agent is palatable to a horse.

A process, method, hay-based material, treated hay or machine as defined in any one of [1]-[21] above, wherein the binding agent or dust-trapping agent is an organic substance, chemical substance or a combination thereof; preferably the organic substance is selected from the group consisting of: 1) plant-based oils such as soybean, vegetable, corn, canola, peanut, colza, castor, linseed, olive, avocado, grape, almond, wheat germ, coconut, cottonseed, palm, rapeseed, sesame, and sunflower, 2) fatty acids and animal-based oils such as hydrogenated oils, and fish oils, 3) molasses, 4) natural gums and combinations thereof, and preferably the chemical substance is selected from the group consisting of, 1) lignin sulfonate-based substances, 2) bentonite-based substances, 3) protein and gelatin-based substances, 4) urea formaldehyde-based substances, 5) substances formed from sodium carbonate pulping liquor, 6) substances formed from water soluble forms of calcium, and combinations thereof.

A process, method, hay-based material, treated hay or machine as defined in any one of [1]-[21] above, wherein the nutrients mix comprises a component selected from the group consisting of selenium, a product offering a grouping of essential minerals including but not limited to salt, iron sulfate, copper sulfate, zinc sulfate, magnesium oxide, mineral oil, and sodium selenite; preferably, the nutrients mix is adapted to suit the particular circumstances dictated by the health condition of a horse.

A process, method, hay-based material, treated hay or machine as defined in any one of [1]-[21] above, wherein the hay-based material or treated hay is substantially free of emission of antigens and other respirable dust particles.

A method of feeding a horse, comprising using the hay-based material or treated hay as defined in any one of [1]-[21] above.

A method of feeding a horse with severe asthma, comprising using the hay-based material or treated hay as defined in any one of [1]-[21] above.

A method of improving the general health, lung function and/or neutrophilic inflammation in a horse with severe asthma, comprising using the hay-based material or treated hay as defined in any one of [1]-[21] above.

A method of decreasing anti-oxidant enzymes activity in a horse with severe asthma, comprising using the hay-based material or treated hay as defined in any one of [1]-[21] above.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Photograph of the machine according to the invention showing external components thereof.

FIG. 2: Machine according to the invention showing components thereof.

FIG. 3: Photograph of the machine according to the invention. A) Front view, B) Control panel.

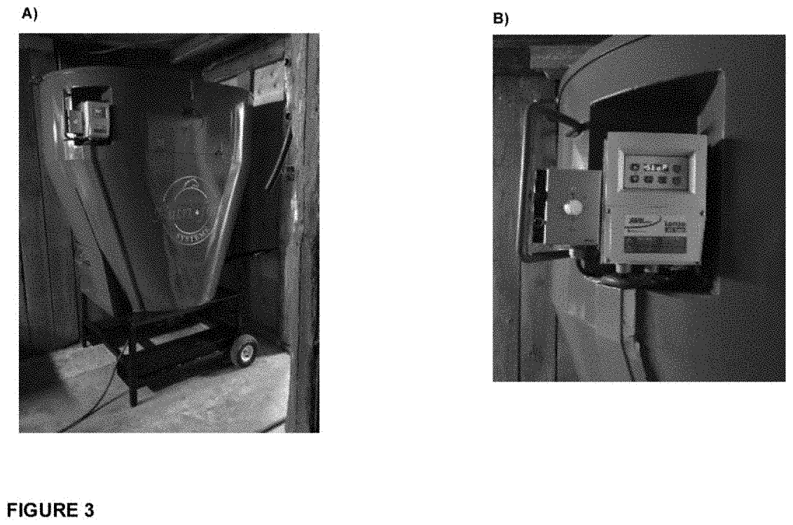

FIG. 4: Photograph of the machine according to the invention. A) Loading door B); Access door.

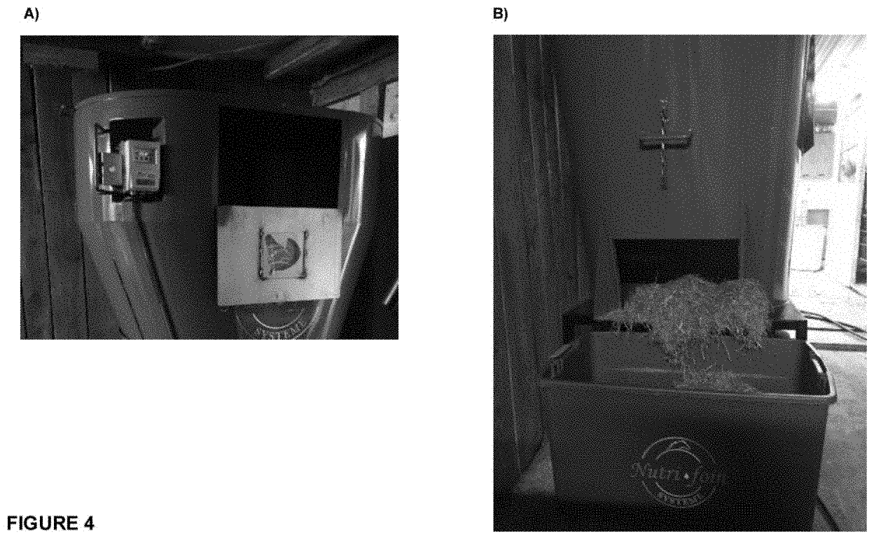

FIG. 5: Photograph of the machine according to the invention. A) Interior view showing auger; B) Motor and gearbox.

FIG. 6: Photograph of the machine according to the invention showing the auger.

FIG. 7: Photograph of the machine according to the invention showing the access door.

FIG. 8: Photograph of the machine according to the invention showing various views thereof.

FIG. 9: Comparing effects of Nutri-foin hay and alfalfa pellets on severe asthmatic horse—Procedure and schedule and methods.

FIG. 10: Comparing effects of Nutri-foin hay and alfalfa pellets on severe asthmatic horse—Horses weight.

FIG. 11: Comparing effects of Nutri-foin hay and alfalfa pellets on severe asthmatic horse—A) Resistance; B) Elastance.

FIG. 12: Comparing effects of Nutri-foin hay and alfalfa pellets on severe asthmatic horse—Residual bronchoconstriction A1) and A2) Nutri-foin hay; B1) and B2) Alfalfa pellets.

FIG. 13: Comparing effects of Nutri-foin hay and alfalfa pellets on severe asthmatic horse—Neutrophilia.

FIG. 14: Comparing effects of Nutri-foin hay and alfalfa pellets on severe asthmatic horse—Anti-oxidant enzymes kinetics A) SOD activity; B) GPX activity.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments, and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

As used herein, the term “binding agent” refers to a substance which can be safely consumed by a horse and which acts in a manner to adhere or trap allergens and other respirable dust particles to a hay material, thus preventing their aerosolization. In the present disclosure, the term “binding agent” is used interchangeably with the term “dust-trapping agent”.

As used herein, the term “nutrients mix” refers to a mixture comprising elements that contribute to the general well-being of a horse.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or containing” (and any form of containing, such as “contain” and “contains”), are inclusive or open-ended and do not exclude additional, unrecited elements or process steps.

As used herein the term “about” is used to indicate that a value includes an inherent variation of error for the device or the method being employed to determine the value.

The inventors have designed and prepared a hay-based material that is free of emission of antigens and other respirable dust particles. The material according to the invention comprises hay and a binding agent or dust-trapping agent. The material may also comprise a nutrients mix.

The process for the preparation of the material according to the invention comprises a combination of a mechanical manipulation of hay and use of a binding agent or dust-trapping agent. The mechanical manipulation comprises chopping/blending hay.

The machine for the preparation of the material according to the invention comprises a chopper/blender and a dispenser operatively attached thereto. The machine of the invention allows for a binding agent or dust-trapping agent to be dispensed into the chopper/blender during operation thereof. In embodiments of the invention, the binding agent or dust-trapping agent may be in substantially liquid form and the dispenser may be a liquid dispenser.

The hay-based material according to the invention may be used to feed horses to improve their general health, particularly horses with severe asthma.

In particular, the invention relates to a method for neutralizing the aerosolization of organic dust particles and/or allergens normally occurring during consumption of hay by horses, thereby creating an alternative process for conducting effective management of a horse's breathing environment. The process according to the invention comprises performing a mechanical chopping/blending operation in a specifically designed machine in order to integrate a binding agent or dust-trapping agent into the hay, creating an adhesion effect on respirable allergens. The binding agent or dust-trapping agent used in the invention is further described in detail below.

The present invention is illustrated in further details by the following non-limiting examples.

### Example 1—the Processing Machine

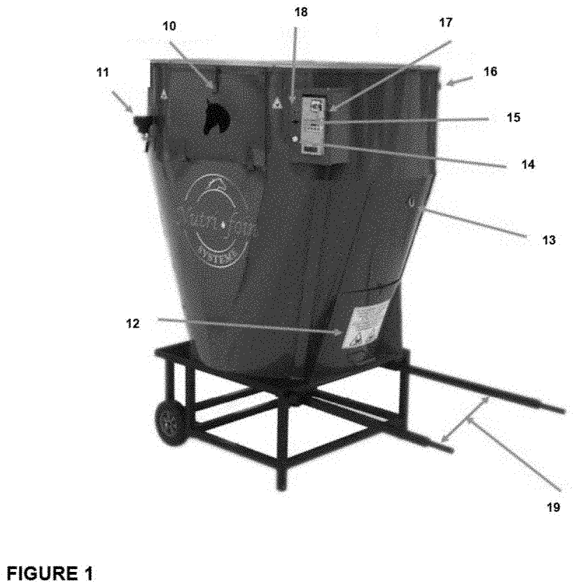

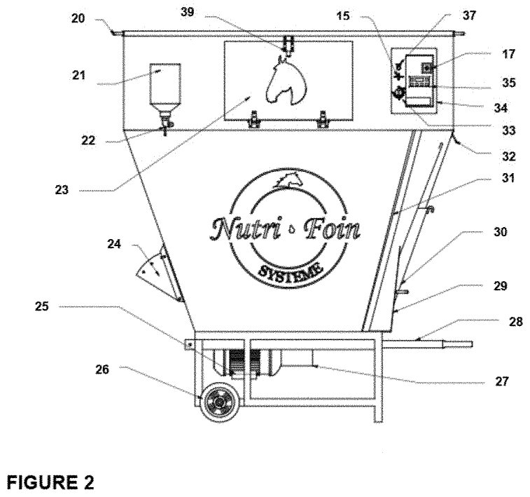

FIG. 1 is a photograph of the machine according to the invention (“Nutri Foin Systeme”). External components of the machine are outlined including: an entry door (10), a dispenser (11), an exit door (12), a latch (13), a timer (14) a directional switch (15), a negative pressure port (16) which may or may be present or absent, a main power switch (17) with lock, an evacuation button (18) and a lever arm (19). Other components of the machine according to the invention are outlined in FIG. 2. These include: a removable lid (20), a bottle for holding a liquid (21), a flow control valve (22), a side door (23), an adjustable diffusion plate (24), a motor (25), a wheel (26), a transfer box (27), a retractable handle (28), an outlet deflector (29), a sliding door (30), a wiring protector (31), a sliding door fastener (32), a timer (33), a housing (34), a controller (35), a main power switch (17), a hay evacuation (37), a directional switch (15) and a door lock (39).

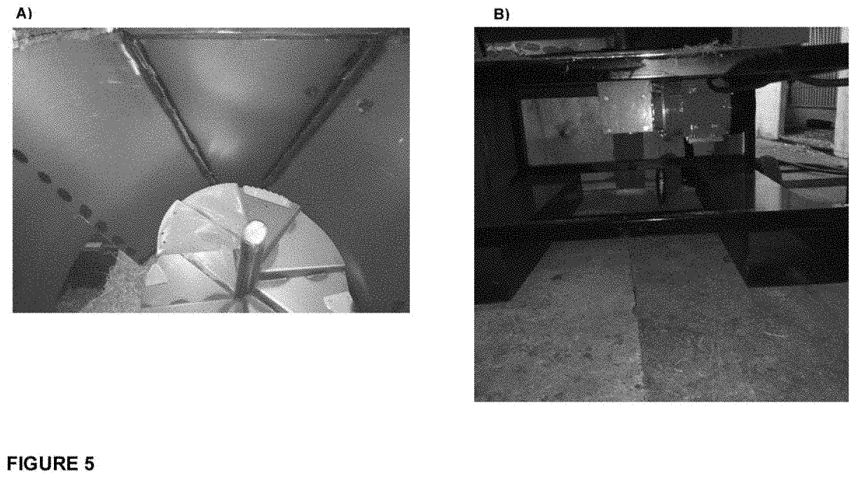

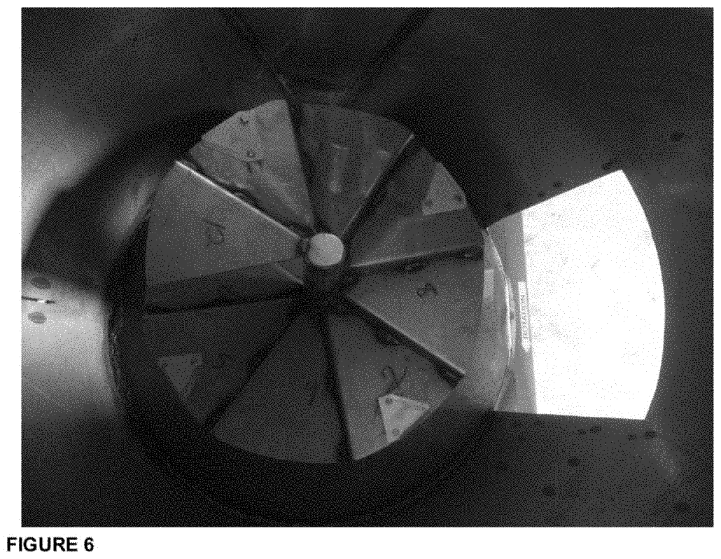

The machine according to the invention is generally composed of several steel pieces which are welded together to form a mixing tub, and consisting of two tub component pieces, a plate, an extension piece with loading door, a base, and a cover. This structure is welded to a metal frame, and provides the housing (34) into which the auger assembly (FIGS. 5A and 6) is positioned. The auger assembly is composed of several auger plates, stoppers, and blade components (FIGS. 5A and 6) which are arranged and welded in a cylindrical manner to a tube. The tube and auger assembly are mounted on a shaft component which is connected to a gear box housed beneath the base, and attached to the metal frame. The electric motor (25) is also affixed to the metal frame to drive the gear box (FIG. 5B), and is electronically controlled by the control panel (35) integrated into the extension piece of the tub. The control panel provides a breaker switch to engage operation mode, and is connected to a timer device (33) to govern the length of time of rotation of the auger. Attached to the side of the tub is the oil dispensing unit which incorporates the bottle for holding a liquid (21) and the flaw control valve (22). The oil dispensing unit functions with the force of gravity to dispense the oil into the tub during operation of the machine.

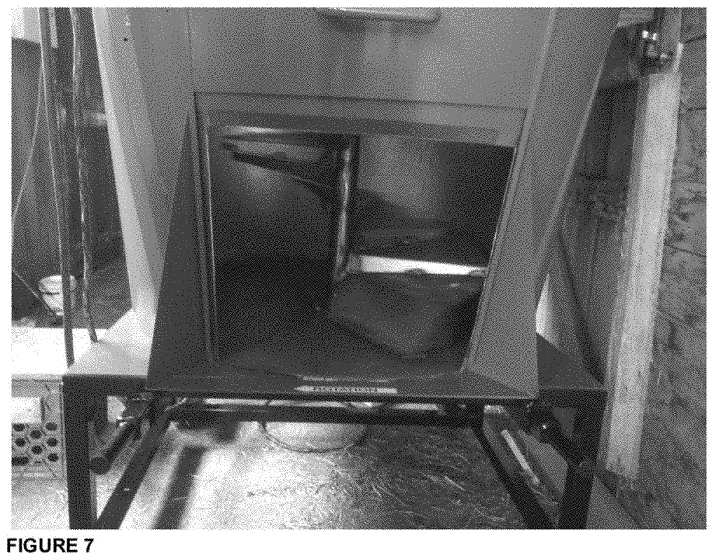

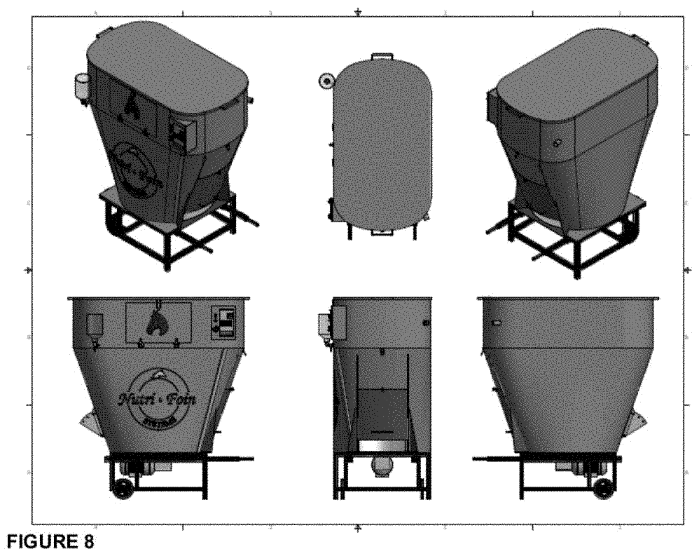

The access door of the machine is further outlined in FIG. 7, and various views of the machine are outlined in FIG. 8.

### Example 2—the Binding or Dust-Trapping Agent

In embodiments of the invention, a soybean-based oil is used as binding agent or dust-trapping agent. This is due to its desirable, naturally-occurring antioxidant properties, in combination with it being highly palatable to horses. Such soybean-based oil has the make-up described in Table I below.

However as will be understood by a skilled person, any suitable binding agent or dust-trapping agent may be used which is consumable by a horse; and preferably, which is palatable to the horse. Such binding agents or dust-trapping agents may be organic substances or chemical substances. Organic substances include but are not limited to: 1) plant-based oils such as soybean, vegetable, corn, canola, peanut, colza, castor, linseed, olive, avocado, grape, almond, wheat germ, coconut, cottonseed, palm, rapeseed, sesame, and sunflower, 2) fatty acids and animal-based oils such as hydrogenated oils, and fish oils, 3) molasses, and 4) natural gums. Chemical substances include but are not limited to: 1) lignin sulfonate-based substances disclosed for example in U.S. Pat. No. 4,698,225, 2) bentonite-based substances disclosed for example in U.S. Pat. No. 2,162,609, 3) protein and gelatin-based substances, 4) urea formaldehyde-based substances, 5) substances formed from sodium carbonate pulping liquor disclosed for example in U.S. Pat. No. 5,714,184, and 6) substances formed from water soluble forms of calcium disclosed for example in U.S. Pat. No. 4,988,520. Combinations of such substances may also be used.

TABLE 1
Make-up of a soya-based oil
Guarantied analysis

| | | |
|---|---|---|
| Humidity | 0.22% | max. |
| Total fatty acids | 98.00% | max. |
| Insoluble substances | 0.02% | max. |
| Non-saponifiable substances | 0.60% | max. |
| Metabolizing energy (horse) | 8980.00 | Kcal/Kg |

Fatty acids content expressed as % of total fatty acids

| | |
|---|---|
| C14:0 Myrictic | 0.07% |
| C16:0 Palmitic | 10.03% |
| C16:1 Cis-9 Palmitoleic | 0.11% |
| C18:0 Stearic | 4.00% |
| C18:1 Cis-9 Oleic | 22.50% |
| C18:2 Cis-9,12 Linoleic | 53.10% |
| C18:3 Cis-9,12,15 Linolenic | 9.10% |
| C20:0 Arachidic | 0.15% |

Natural antioxydant

| | | |
|---|---|---|
| Tocopherol (vitamin E) | 1566.00 | ppm |

### Example 3—Formulation of the Nutrients Mix

In embodiments of the inventions, the suggested nutrients mix primarily comprises selenium. The nutrients mix used in the invention may also comprise any commercially available product offering a grouping of essential minerals, such as salt, iron sulfate, copper sulfate, zinc sulfate, magnesium oxide, mineral oil, and sodium selenite. A nutrients mix may be adapted to suit the particular circumstances dictated by the health condition of a horse.

### Example 4—Capacities and Dosages

The processing machine is designed to accommodate about one 40-50 lbs bale of hay per operating cycle, which produces about 4 feedings for a single horse (or 2 days worth). For each operating cycle of the processing machine, the recommended dosage of consumable oil is about 400 mL.

### Example 5—Process Steps

The processing cycle for each bale of hay requires about 11-13 minutes, plus 1-2 minutes of set-up time. The timeline below describes the steps of the process underlying the invention.

### Time 0 to 2 Minutes:

Pre-operation preparation—empty the machine of all previous contents, and remove tie cords from hay bale to be processed. Separate the hay bale into 3 or more large sections. Poor about 400 mL of consumable oil into the oil dispenser, with the dispensing valve closed.

### Time 2 to 4 Minutes:

Operating procedure begins—introduce the sections of hay into the machine through the loading door, as well as the nutrients mix. Adjust the timer to operate the machine for 11 minutes. Start the operation of the machine, and within about 30 seconds open the dispensing valve on the oil dispenser. The oil is fully dispensed within about 2 minutes of the machine being put into operation.

### Time 4 to 11-13 Minutes:

Continue to allow the machine to operate normally. Once the timer has elapsed, open the access door and inspect the hay for dust content. This can be done by taking a handful of hay in one hand, and applying a vigorous tapping action to the hay with the other hand, to determine if respirable organic dust particles are still being emitted. If it appears that respirable dust remains, re-engage the machine for an additional 2 to 3 minutes depending on the original consistency of the hay. Finer hay will require less additional processing time, while coarser hay may receive longer additional processing time.

Once the operation above has been completed, hay may be provided to horses right away, or stored for later use. Hay treated according to the process of the invention may be stored for up to about 2 weeks.

As will be understood by a skilled person, the invention provides a dry process which is mechanically assisted to eliminate the emission of organic dust particles normally occurring during consumption by horses. This is different form exposing hay to water or steam. The invention allows for management of a horse's breathing environment, eliminating the need for drug treatments.

The invention proposes a method of managing the symptoms and respiratory inflammation associated with SEA, in the absence of any drug treatments. As such, over the long-term, the invention carries lower costs and risks as compared to those associated with drug treatment regimens.

The invention incorporates a specifically designed machine to execute the process, and requires only between about 11-13 minutes to neutralize respirable organic dust from enough hay to fulfill daily requirements for 1-2 horses. This compares to 30-45 minutes for the hay steamer, and 60 minutes for hay soaking. Hay is not required to be manually broken apart, or shaken out before loading, and can be directly loaded in bail form into the machine. Once processed, hay can be extracted through a convenient access door for loading into a wheelbarrow, and subsequent feeding to horses in stalls or outdoors.

As hay subjected to the process according to the invention is not exposed to moisture, there is far lesser risk of development of harmful toxins as compared to hay which has been soaked or steamed. In addition, hay which has been processed can be stored for up to about 2 weeks and safely re-fed to horses, which compares to a shelf-life of only 12 hours for silage or soaked/steamed hay.

Conventional hay is generally known to be the best form of food to give a horse, given its roughage qualities which are important for horse digestion. As the invention does not require hay to be exposed to water or heat, it does not cause a dilutive effect on the nutritive content of the treated hay.

### Example 6—Effects on Severe Asthmatic Horses

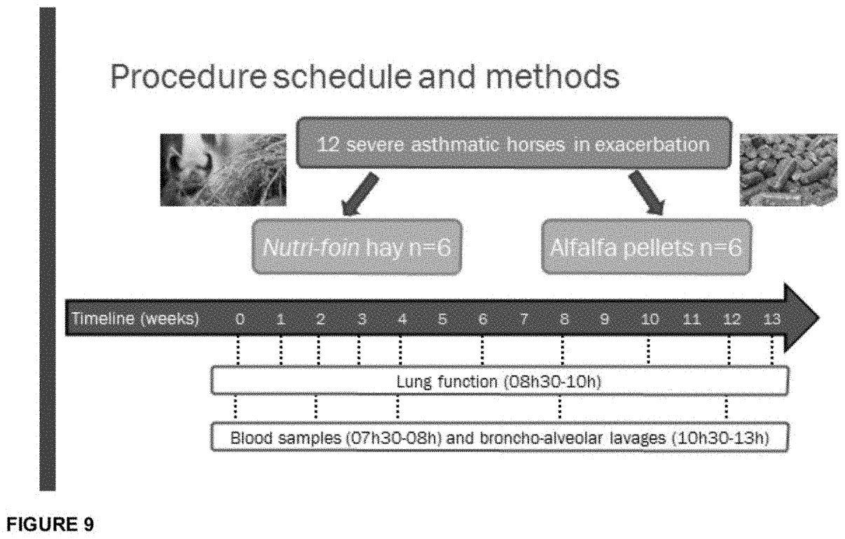

Work aiming at comparing the effects in severe asthmatic horses of hay treated by the process according to the invention (Nutri-foin hay) and alfalfa pellets. In particular, the effects on lung functions, airway inflammation and blood serum oxidative stress. The procedure schedule and methods are outlined in FIG. 9. Twelve severe asthmatic horses were involved in the study six horses were fed hay treated by the process of the invention and the six others were fed alfalfa pellets. The treatment of hay according to the invention took approximately 30 minutes, and the treated hay (Nutri-foin hay) appeared palatable and smooth. In this example, soybean oil was used in the treatment. Both Nutri-foin and alfalfa regimens were well tolerated by the horses. It should be noted that one horse from the treated hay group was removed from the study due to an unrelated medical condition.

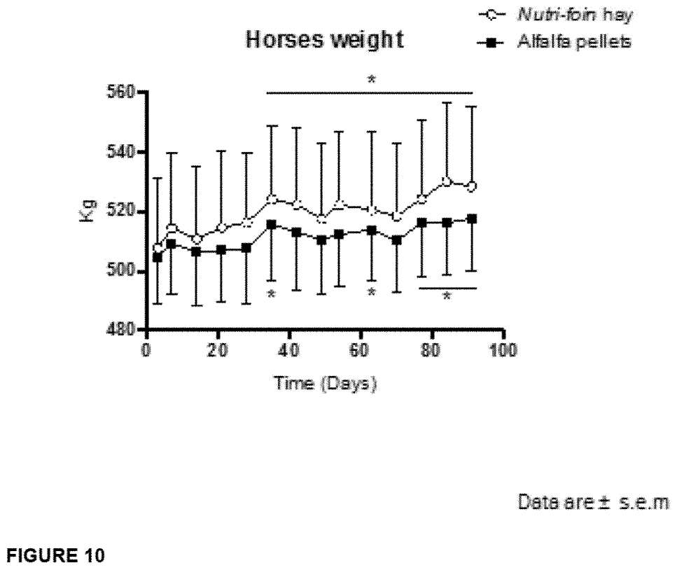

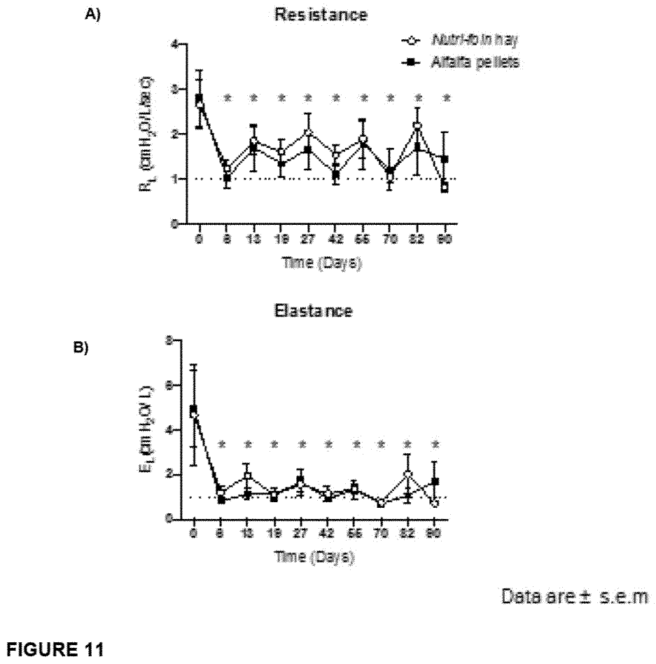

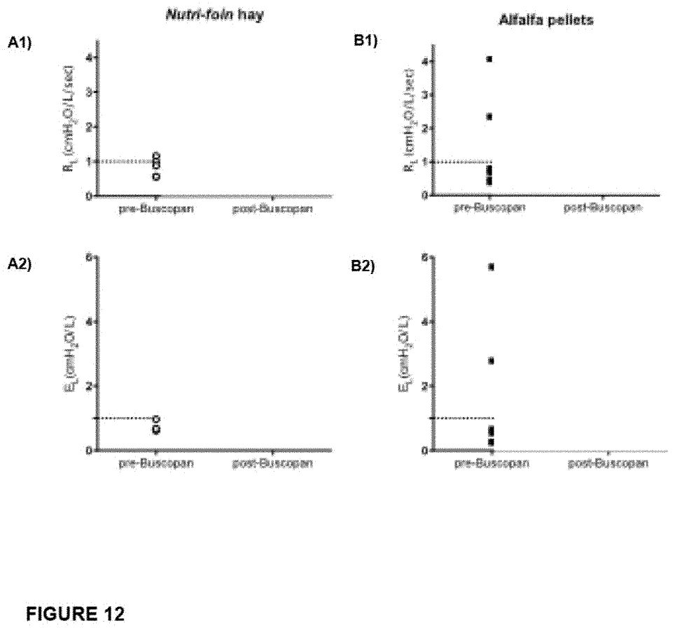

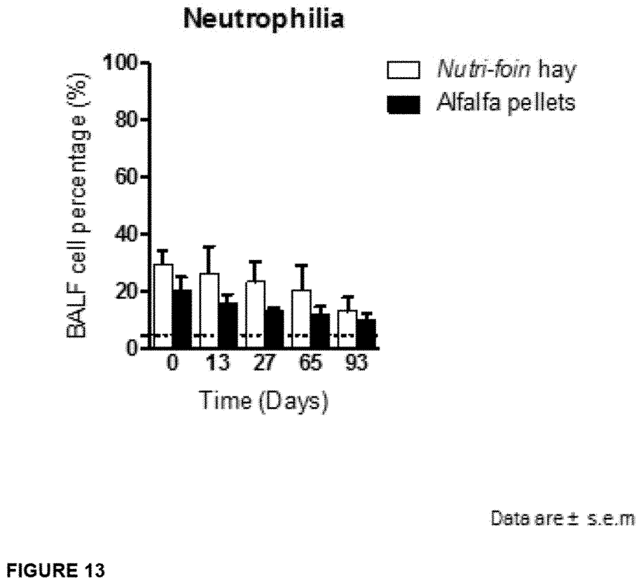

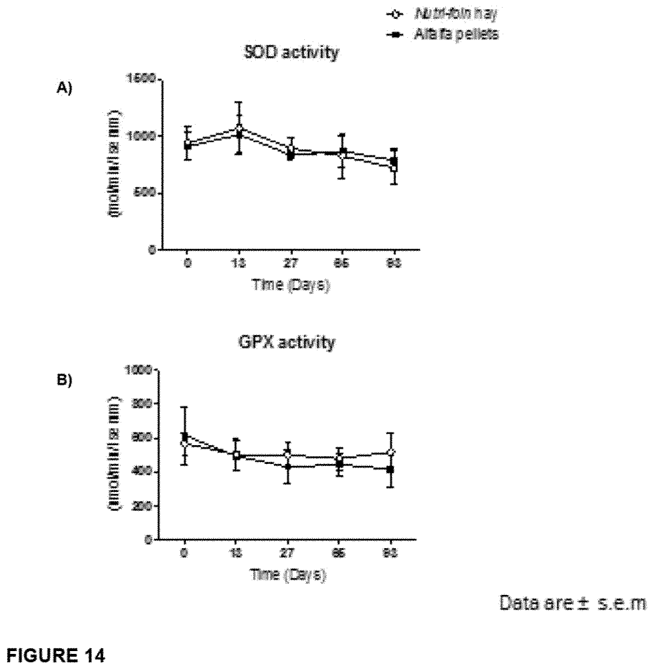

As can be seen in FIG. 10, significant weight gain was observed in both groups. Physiological respiratory responses were assessed through resistance and elastance. The results obtained are illustrated in FIGS. 11A and 11B. As can be seen a significant time effect was observed, but with no group or group X time interaction. Regarding Residual bronchoconstriction, significant diminution of the pulmonary elastance was observed in horses fed with the Nutri-foin hay. This is illustrated in FIGS. 12A1, 12A2, 12B1 and 12B2. FIG. 13 shows the results obtained for airway neutrophilia. As can be seen no significant time of group effects were observed. Kinetics of anti-oxidant enzymes were assessed, through superoxide dismutase (SOD) and glutathione peroxidase (GPX) activities. The results obtained are outlined in FIGS. 14A and 14B. Measurements were conducted in serum at various times. A significant time effect without group differences or time and group interaction was observed.

Accordingly, hay treated by the process of the invention is palatable and well tolerated by horses including horses with severe asthma. Use of the hay of the invention is demonstrated to improve the general health, the lung functions and/or the neutrophilic inflammation in a horse with severe asthma. Use of the hay according to the invention is demonstrated to reduce and/or eliminate symptoms associated with severe equine asthma at a similar efficacy to that demonstrated by use of alfalfa pellets. Also, use of the hay of the invention decreases anti-oxidant enzymes activity in the horse over time.

The scope of the claims should not be limited by the preferred embodiments set forth in the examples, but should be given the broadest interpretation consistent with the description as a whole.

The present description refers to a number of documents, the content of which is herein incorporated by reference in their entirety.

### REFERENCES

1. Couëtil, L. L., Cardwell, J. M., Gerber, V., Lavoie, J.-P., Lguiilette, R. and Richard, E. A. (2016), Inflammatory Airway Disease of Horses—Revised Consensus Statement. Journal of Veterinary Internal Medicine, 30 (2), pp. 503-515.
2. Léguillette, R. (2003), Recurrent airway obstruction—heaves. The Veterinary Clinics Equine Practice, 19 (1), pp. 63-86.
3. Hotchkiss, J. W., Reid, S. W. J, and Christley, R. M., (2007). A survey of horse owners in Great Britain regarding horses in their care. Part 2: Risk factors for recurrent airway obstruction. Equine Veterinary Journal, 39 (4), pp. 301-308.
4. Evans, Vel. (Apr. 5, 2014). Harnessing Horsepower in the Hills of Headwater. Retrieved from http://headwatershorsecountry.ca/wp-content/uploads/sites/4/2014/05/Equine-Forum-2011-Strategic-Equine-compressed.pdf.
5. 2002 USEF demographics. (2002). Retrieved from http://www.theequestrianchannel.com/sitebuildercontent/sitebuilderfiles/2002USEFdemographics.pdf.

1. A process for preparing a hay-based material, comprising chopping/blending together hay and a binding agent or dust-trapping agent.

2. A process for preparing a hay-based material, comprising chopping/blending together hay, a nutrients mix and a binding agent or dust-trapping agent.

3. A process for preparing a hay-based material, comprising, in combination: a mechanical operation involving chopping/blending of hay, and use of a binding agent or dust-trapping agent.

4. A process for preparing a hay-based material, comprising, in combination: a mechanical operation involving chopping/blending of hay and a nutrient mix, and use of a binding agent or dust-trapping agent.

5. A process for preparing a hay-based material, comprising: (a) chopping hay to obtain a chopped hay; (b) adding a binding agent or dust-trapping agent to the chopped hay to obtain a mixture; and (c) blending the mixture to obtain the hay-based material.

6. A process according to claim 5, further comprising (al) mixing hay with a nutrients mix prior to conducting step (a).

7. A process for preparing a hay-based material, comprising: (a) providing hay into a chopper/blender; (b) providing a binding agent or dust-trapping agent into a dispenser that is operatively attached to the chopper/blender; (c) operating the chopper/blender; (d) causing the dispenser to dispense the binding agent or dust-trapping agent into the chopper/blender; (e) stopping operation of the chopper/blender; and (f) retrieving the material.

8. A process according to claim 7, further comprising (al) mixing hay with a nutrients mix prior to conducting step (a).

9. A process according to claim 7, wherein step (d) proceeds automatically after a set period of time.

10. A process according to claim 7, wherein step (e) is performed after a period of time.

11. A process according to claim 7, further comprising (g) assessing the presence of any dust in the material, and optionally repeating at least one of steps (c)-(f).

12. A process according to claim 7, further comprising (h) assessing the consistency of the material, and optionally repeating at least one of steps (c)-(f).

13. A process according to claim 7, further comprising (i) storing the material for future use.

14. A process according to claim 7, wherein the binding agent or dust-trapping agent is in substantially liquid form and the dispenser is a liquid dispenser.

15. A method for treating hay, comprising, in combination, a mechanical manipulation of hay and use of a binding agent or dust-trapping agent.

16. A method according to claim 15, wherein hay comprises a nutrients mix.

17. A hay-based material obtained by the process as defined in any one of claims 1-14.

18. Hay treated by the method as defined in claim 15 or 16.

19. A machine for producing hay-based material, comprising a hay chopper/blender and a dispenser operatively attached thereto, wherein a binding agent or dust-trapping agent provided into the dispenser is dispensed into the chopper/blender during operation thereof.

20. A machine according to claim 19, wherein the hay comprises a nutrients mix.

21. A machine according to claim 19, wherein the binding agent or dust-trapping agent is in substantially liquid form and the dispenser is a liquid dispenser.

22. A process, material or machine as defined in any one of claims 1-21, wherein the hay-based material is for feeding a horse.

23. A process, method, hay-based material, treated hay or machine as defined in any one of claims 1-21, wherein the binding agent or dust-trapping agent is consumable by a horse; preferably the binding agent or dust-trapping agent is palatable to a horse.

24. A process, method, hay-based material, treated hay or machine as defined in any one of claims 1-21, wherein the binding agent or dust-trapping agent is an organic substance, chemical substance or a combination thereof; preferably the organic substance is selected from the group consisting of, 1) plant-based oils such as soybean, vegetable, corn, canola, peanut, colza, castor, linseed, olive, avocado, grape, almond, wheat germ, coconut, cottonseed, palm, rapeseed, sesame, and sunflower, 2) fatty acids and animal-based oils such as hydrogenated oils, and fish oils, 3) molasses, 4) natural gums and combinations thereof; and preferably the chemical substance is selected from the group consisting of: 1) lignin sulfonate-based substances, 2) bentonite-based substances, 3) protein and gelatin-based substances, 4) urea formaldehyde-based substances, 5) substances formed from sodium carbonate pulping liquor, 6) substances formed from water soluble forms of calcium, and combinations thereof.

25. A process, method, hay-based material, treated hay or machine as defined in any one of claims 1-21, wherein the nutrients mix comprises a component selected from the group consisting of: selenium, a product offering a grouping of essential minerals including but not limited to salt, iron sulfate, copper sulfate, zinc sulfate, magnesium oxide, mineral oil, and sodium selenite; preferably, the nutrients mix is adapted to suit the particular circumstances dictated by the health condition of a horse.

26. A process, method, hay-based material, treated hay or machine as defined in any one of claims 1-21, wherein the hay-based material or treated hay is substantially free of emission of antigens and other respirable dust particles.

27. A method of feeding a horse, comprising using the hay-based material or treated hay as defined in any one of claims 1-21.

28. A method of feeding a horse with severe asthma, comprising using the hay-based material or treated hay as defined in any one of claims 1-21.

29. A method of improving the general health, lung function and/or neutrophilic inflammation in a horse with severe asthma, comprising using the hay-based material or treated hay as defined in any one of claims 1-21.

30. A method of decreasing anti-oxidant enzymes activity in a horse with severe asthma, comprising using the hay-based material or treated hay as defined in any one of claims 1-21.
